(19) United States
(12) Patent Application Publication
(10) Pub. No.: US 2026/0062053 A1
(43) Pub. Date: Mar. 5, 2026

(54) CONTROL DEVICE, CONTROL METHOD, AND NON-TRANSITORY COMPUTER-READABLE STORAGE MEDIUM

(71) Applicant: HONDA MOTOR CO., LTD., Tokyo (JP)

(72) Inventor: Fumiaki YOSHIKAWA, Tokyo (JP)

(73) Assignee: HONDA MOTOR CO., LTD., Tokyo (JP)

(21) Appl. No.: 19/297,836

(22) Filed: Aug. 12, 2025

(30) Foreign Application Priority Data
Aug. 30, 2024 (JP) 2024-148537

(51) Int. Cl. B62D 15/02; B60R 1/26; B62D 13/06

(52) U.S. Cl. CPC B62D 15/0275; B60R 1/26; B62D 13/06; B62D 15/028; B60R 2300/305; B60R 2300/607; B60R 2300/806

(57) ABSTRACT

A control device has a processor which acquires external environment information of a moving object capable of first traveling and second traveling and towing a trailer, and controls to display a peripheral image of the moving object based on the external environment information. The processor controls to display a guide image superimposed on the peripheral image, in a state where the first traveling of the moving object is allowed. The guide image includes a first guide image showing a first traveling path of the moving object or the trailer when the moving object performs the first traveling from a current position, and a second guide image showing a second traveling path of the moving object or the trailer when the moving object performs the second traveling from a position on the first traveling path where a relative angle between the moving object and the trailer is a predetermined angle.

### CROSS-REFERENCE TO RELATED APPLICATIONS

This application is based on and claims priority under 35 USC 119 from Japanese Patent Application No. 2024-148537 filed on Aug. 30, 2024, the entire content of which is incorporated herein by reference.

### TECHNICAL FIELD

The present disclosure relates to a control device, a control method, and a non-transitory computer-readable storage medium storing a control program.

### BACKGROUND ART

In recent years, active efforts have been made to provide access to a sustainable transportation system in consideration of vulnerable people among traffic participants. In order to achieve the above goal, focus has been placed on research and development on further improving safety and convenience of traffic through research and development related to automated driving techniques.

In the related art, there is a known technique for displaying a guide line, which shows a predicted traveling region of a vehicle based on a vehicle traveling state, superimposed on a vehicle peripheral image when the vehicle is traveling or turning. For example, JP2019-069717A describes a parking assistance device including a route acquisition unit that, when a target parking position for a towed vehicle is set, acquires a guidance route that extends from the target parking position as a starting point for guiding the towed vehicle to the target parking position, and a display processing unit that, when the guidance route is acquired, displays the guidance route superimposed on a peripheral image, in which the target parking position includes a pair of target positions that correspond to a vehicle width of the towed vehicle, and the display processing unit displays the guidance route that extends from at least one of the pair of target positions that is on a turning inner side of a towing vehicle, superimposed on the peripheral image.

JP6823097B describes a vehicle including a control module that causes a display to display an area behind the vehicle, a general-purpose steering guide line, and a trailer hitching steering guide line during a vehicle backward traveling event, in which the general-purpose steering guide line starts from an upright side portion, marks a projected track of the vehicle, and has a coverage that is maintained regardless of changing of a steering angle, and the trailer hitching steering guide line starts from a hitch point, marks a projected track of the hitch point, and has a coverage that is adjusted based on the changing of the steering angle.

However, when a vehicle is towing a trailer, if a vehicle guide image and a trailer guide image are displayed, the guide images become complicated and may be difficult for a user to understand. For example, it is often difficult to understand a guide image when a vehicle towing a trailer switches a traveling direction thereof between a backward traveling direction and a forward traveling direction. However, JP2019-069717A and JP6823097B have no description about recognizability of the guide image when the vehicle switches the traveling direction thereof. Therefore, it is required to improve a method for displaying a guide image in a towing vehicle.

### SUMMARY OF INVENTION

An object of the present disclosure is to provide a control device, a control method, and a non-transitory computer-readable storage medium storing a control program that enable easy understanding of a traveling path of a moving object or a trailer. This hence contributes to development of a sustainable transportation system.

A first aspect of the present disclosure relates to a control device, having a processor configured to:
acquire external environment information of a moving object allowed to perform first traveling and second traveling and towing a trailer; and
control to display a peripheral image of the moving object based on the external environment information, in which
the processor controls to display a guide image superimposed on the peripheral image, in a state where the first traveling of the moving object is allowed, and
the guide image includes:
   a first guide image that shows a first traveling path of at least one of the moving object and the trailer in a case where the moving object performs the first traveling from a current position; and
   a second guide image that shows a second traveling path of at least one of the moving object and the trailer in a case where the moving object performs the second traveling from a position on the first traveling path where a relative angle between the moving object and the trailer is a predetermined angle.

A second aspect of the present disclosure relates to a control method of a control device that acquires external environment information of a moving object allowed to perform first traveling and second traveling and towing a trailer, and controls to display a peripheral image of the moving object based on the external environment information, in which
a processor of the control device controls to display a guide image superimposed on the peripheral image, in a state where the first traveling of the moving object is allowed, and
the guide image includes:
   a first guide image that shows a first traveling path of at least one of the moving object and the trailer in a case where the moving object performs the first traveling from a current position; and
   a second guide image that shows a second traveling path of at least one of the moving object and the trailer in a case where the moving object performs the second traveling from a position on the first traveling path where a relative angle between the moving object and the trailer is a predetermined angle.

A third aspect of the present disclosure relates to a non-transitory computer-readable storage medium storing a control program of a control device that acquires external environment information of a moving object allowed to perform first traveling and second traveling and towing a trailer, and controls to display a peripheral image of the moving object based on the external environment information, in which
the control program causes a processor of the control device to control to display a guide image superimposed on the peripheral image, in a state where the first traveling of the moving object is allowed, and
the guide image includes:
   a first guide image that shows a first traveling path of at least one of the moving object and the trailer in a case where the moving object performs the first traveling from a current position; and
   a second guide image that shows a second traveling path of at least one of the moving object and the trailer in a case where the moving object performs the second traveling from a position on the first traveling path where a relative angle between the moving object and the trailer is a predetermined angle.

According to the aspect of the present disclosure, it is possible to provide the control device, the control method, and the non-transitory computer-readable storage medium storing the control program that enable easy understanding of a traveling path of the moving object or the trailer.

### BRIEF DESCRIPTION OF DRAWINGS

Exemplary embodiment(s) of the present invention will be described in detail based on the following figures, wherein:

FIG. 1 is a side view of an example of a vehicle equipped with a control device of the present disclosure;

FIG. 2 is a top view of the vehicle illustrated in FIG. 1;

FIG. 3 is a block diagram illustrating an example of an internal configuration of the vehicle illustrated in FIG. 1;

FIG. 4 is a diagram illustrating an example of a first guide image and a second guide image displayed in a peripheral image of a vehicle 10;

FIG. 5 is a diagram illustrating an example of a peripheral image 5 displayed when a gear position of the vehicle 10 is in Drive;

FIG. 6 is a diagram illustrating a first example of an image of a peripheral region of a vehicle 10a displayed in the peripheral image 5;

FIG. 7 is a diagram illustrating a second example of the image of the peripheral region of the vehicle 10a displayed in the peripheral image 5;

FIG. 8 is a diagram illustrating a first modification of the first guide image and the second guide image displayed in the peripheral image of the vehicle 10;

FIG. 9 is a diagram illustrating a second modification of the first guide image and the second guide image displayed in the peripheral image of the vehicle 10;

FIG. 10 is a diagram illustrating a third modification of the first guide image and the second guide image displayed in the peripheral image of the vehicle 10;

FIG. 11 is a diagram illustrating an example of a guide image displayed in a rear image; and

FIG. 12 is a diagram illustrating an example of the first guide image and the second guide image displayed in the peripheral image when the vehicle 10 travels forward.

### DESCRIPTION OF EMBODIMENTS

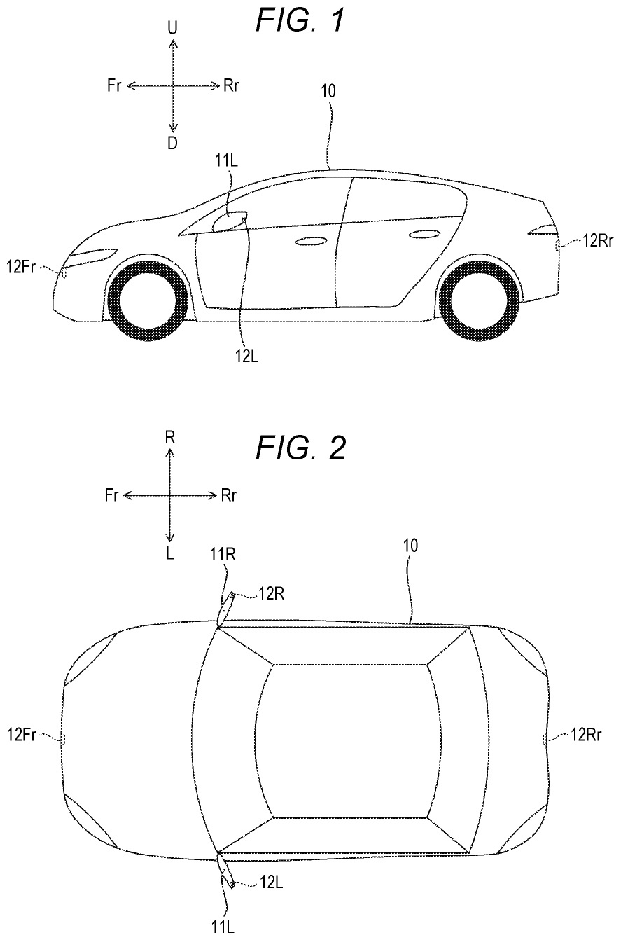

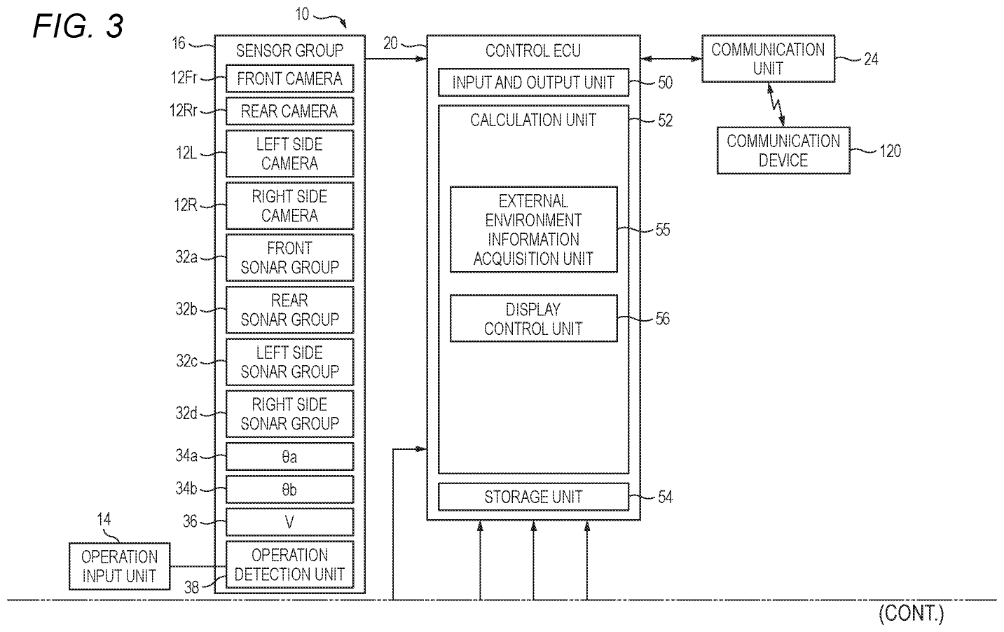

Hereinafter, an embodiment of a control device, a control method, and a control program of the present disclosure will be described with reference to the accompanying drawings. Note that the drawings are viewed in directions of reference numerals. In order to simplify and clarify the description in the present specification or the like, a front-rear direction, a left-right direction, and an upper-lower direction are described according to directions viewed from a driver of a vehicle 10 illustrated in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

### Vehicle 10 Equipped With Control Device

FIG. 1 is a side view of an example of a vehicle equipped with the control device of the present disclosure. FIG. 2 is a top view of the vehicle illustrated in FIG. 1. The vehicle 10 is an example of a “moving object” in the present disclosure.

The vehicle 10 is an automobile including a drive source (not illustrated) and wheels including drive wheels driven by power of the drive source and steerable steered wheels. In the present embodiment, the vehicle 10 is a four-wheeled automobile including a pair of left and right front wheels and a pair of left and right rear wheels. The vehicle 10 is, for example, an automobile capable of towing a trailer or the like. The drive source of the vehicle 10 is, for example, an electric motor. Note that the drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by pivoting about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### Internal Configuration of Vehicle 10

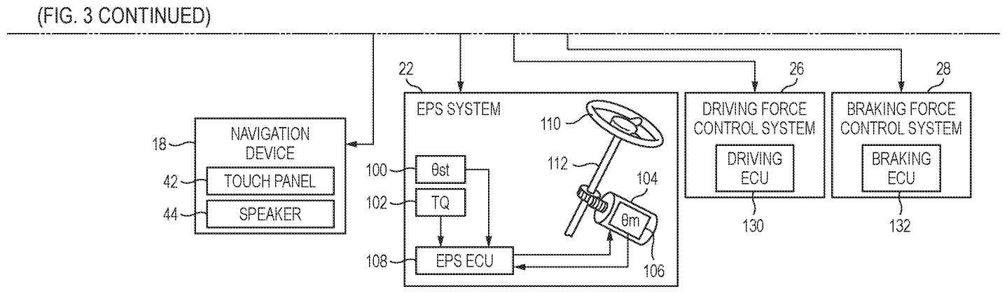

FIG. 3 is a block diagram illustrating an example of an internal configuration of the vehicle illustrated in FIG. 1. As illustrated in FIG. 3, the vehicle 10 includes a sensor group 16, a navigation device 18, a control electronic control unit (ECU) 20, an electric power steering (EPS) system 22, and a communication unit 24. The vehicle 10 includes a driving force control system 26 and a braking force control system 28.

The sensor group 16 acquires various detection values used for control by the control ECU 20. The sensor group 16 includes a front camera 12Fr, a rear camera 12Rr, a left side camera 12L, and a right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire an external environment image for recognizing the vehicle 10 and an external environment of the vehicle 10 by imaging the external environment of the vehicle 10. Peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a lateral side image. An image of the vehicle 10 and the periphery of the vehicle, which is generated by combining the images captured by the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft. Note that the sensor group 16 may also include, for example, an object detection sensor capable of detecting objects in the periphery of the vehicle 10. The objects include a trailer connected to (towed by) the vehicle 10, other vehicles present in the periphery of the vehicle, and the like. The object detection sensor includes, for example, a radar, light detection and ranging or laser imaging detection and ranging (Lidar), a sonar, a yaw rate sensor, a magnetic sensor, and a steering angle sensor.

The operation detection unit 38 detects an operation content of a user performed using an operation input unit 14, and outputs the detected operation content to the control ECU 20. The operation input unit 14 includes various user interfaces such as a side mirror switch that switches the side mirrors 11L and 11R between opened and closed states, and a shift lever (a selector lever or a selector).

The navigation device 18 detects a current position of the vehicle 10 by using, for example, a global positioning system (GPS), and guides the user along a path to a destination. The navigation device 18 includes a storage device (not illustrated) including a map information database.

The navigation device 18 includes a touch panel 42 and a speaker 44. The touch panel 42 functions as an input device and a display device of the control ECU 20. The speaker 44 outputs various types of guidance information to the user of the vehicle 10 by voice.

The touch panel 42 enables input of various commands to the control ECU 20. For example, the user can input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes an automated parking button for requesting parking by automatic steering of the control ECU 20, and a parking support button for requesting support while parking the vehicle by an operation of the user. The exiting assistance button includes an automated exiting button for requesting exiting by the automatic steering of the control ECU 20, and an exiting support button for requesting support while exiting by an operation of the user. For example, the touch panel 42 displays the top view image generated by combining the images captured by the front camera 12Fr, the rear camera 12Rr, the left side camera 12L, and the right side camera 12R. Note that a constituent element other than the touch panel 42, for example, an information terminal such as a smartphone or a tablet may be used as the input device or the display device.

The control ECU 20 includes an input and output unit 50, a calculation unit 52, and a storage unit 54. The calculation unit 52 is implemented by, for example, a central processing unit (CPU). The calculation unit 52 executes various types of control by controlling each unit based on a program stored in the storage unit 54. The calculation unit 52 receives and outputs signals from and to each unit connected to the control ECU 20 via the input and output unit 50. The control ECU 20 is an example of a “control device” in the present disclosure.

The calculation unit 52 includes an external environment information acquisition unit 55 and a display control unit 56.

The external environment information acquisition unit 55 acquires external environment images of the vehicle 10 captured by the front camera 12Fr, the rear camera 12Rr, the left side camera 12L, and the right side camera 12R from the cameras. The external environment information acquisition unit 55 acquires external environment information of the vehicle 10 towing a trailer based on the external environment images acquired from the cameras.

The display control unit 56 controls to display a peripheral image of the vehicle 10 based on the external environment information acquired by the external environment information acquisition unit 55. The “peripheral image” includes the top view image, the rear image, the left side image, the right side image (side images), and the like. The peripheral image may include not only the images of the periphery but also an image of the vehicle 10 (for example, an image of the vehicle 10 in the top view image). The peripheral image may also be generated by combining a plurality of pieces of external environment information.

The vehicle 10 is capable of performing, for example, first traveling and second traveling while towing the trailer. The “first traveling” refers to traveling with a transmission mode in a reverse state, that is, “backward traveling”. The “second traveling” refers to traveling with the transmission mode in a drive state, that is, “forward traveling”. The second traveling is traveling in which a rotation direction of the wheels is opposite to that in the first traveling. In a state where the first traveling of the vehicle 10 is allowed, the display control unit 56 controls to display a guide image superimposed on the peripheral image of the vehicle 10. The “state where the first traveling of the vehicle 10 is allowed” refers to a state where a gear position (transmission mode) is in the reverse state. Note that the state where the first traveling of the vehicle 10 is allowed may be a state where the vehicle 10 is in backward traveling.

The guide image displayed superimposed on the peripheral image includes a first guide image showing a first traveling path of at least one of the vehicle 10 and the trailer towed by the vehicle 10 in a case where the vehicle 10 performs the first traveling from the current position, and a second guide image showing a second traveling path of at least one of the vehicle 10 and the trailer towed by the vehicle 10 in a case where the vehicle 10 performs the second traveling from a position on the first traveling path where a relative angle between the vehicle 10 and the trailer towed by the vehicle 10 is a predetermined angle.

The “first traveling path” is a path calculated from a current position and a current orientation of the vehicle 10, a hitch angle of the trailer, specification information (shape (including size), wheel position, and the like) of the trailer, and a direction of the first traveling. The direction of the first traveling is a direction in which the vehicle 10 towing the trailer is caused to travel backward, and is a direction that the user can select within a range of, for example,-30 degrees to +30 degrees. The “relative angle” refers to the hitch angle of the trailer. The “predetermined angle” is, for example, 0 degree. The predetermined angle may be an angle in a range close to 0 degree (for example, −5 degrees to +5 degrees). The “case where the vehicle 10 performs the second traveling” refers to, for example, a case where the vehicle 10 travels forward (that is, goes straight) with the relative angle remaining at the predetermined angle, that is, with a steering angle of approximately 0 degree.

The display control unit 56 controls to display the first guide image and the second guide image superimposed on the peripheral image, in which the first guide image and the second guide image do not overlap each other. “the first guide image and the second guide image do not overlap each other” means, for example, that there is no region in which both the first guide image and the second guide image are visible. For example, when the second guide image is superimposed on the first guide image and a transmittance higher than 0 is set for the second guide image, both the first guide image and the second guide image are visible, and therefore the first guide image and the second guide image overlap each other. The display control unit 56 controls to display the first guide image and the second guide image superimposed on the peripheral image in different display modes. The “display mode” refers to, for example, the shape (double-line, solid-colored), color, line type, transparency, and combinations of the above of the guide image.

The display control unit 56 controls to display the top view image in the state where the first traveling of the vehicle 10 is allowed with a larger region on a side of the direction of the first traveling as viewed from the vehicle 10, as compared with the top view image in the state where the second traveling of the vehicle 10 is allowed. For example, when the vehicle 10 is traveling backward, the display control unit 56 generates a top view image in which a region on a backward traveling direction side as viewed from the vehicle 10 is displayed larger. When the vehicle 10 is traveling forward, the display control unit 56 generates a top view image in which a region on a forward traveling direction side as viewed from the vehicle 10 is displayed larger.

The display control unit 56 controls to display a top view image including a first range showing a first peripheral region of the vehicle 10 is generated based on the external environment information of the vehicle 10, and a second range showing a second peripheral region of the vehicle 10 including a region farther from the vehicle 10 than the first peripheral region and generated based on peripheral information, which is different from the external environment information of the vehicle 10, of the vehicle 10. The “peripheral information” is, for example, map information stored in a map information database of the navigation device 18. The “first peripheral region” and the “second peripheral region” refer to real spatial regions. The “first range” and the “second range” refer to ranges within the image.

When it is unable to acquire the peripheral information of the vehicle 10, the display control unit 56 controls to display an image stored in the storage unit 54 in advance as the second range showing the second peripheral region of the vehicle 10 in the top view image. The “image stored in advance” is, for example, a mask image that is created in advance.

The display control unit 56 controls to display the first guide image and the second guide image superimposed on the first range and the second range. The display control unit 56 controls to display the first guide image and the second guide image not only superimposed on the first range generated based on the external environment information, but also superimposed on the second range that is larger than the first range.

The calculation unit 52 performs automated parking assistance and automated exiting assistance of the vehicle 10 by the automatic steering for automatically operating a steering 110 under control of the calculation unit 52. In the automated parking assistance and the automated exiting assistance, an accelerator pedal (not illustrated), a brake pedal (not illustrated), and the operation input unit 14 are automatically operated. The calculation unit 52 performs parking support assistance and exiting support assistance when the user (driver) operates the accelerator pedal, the brake pedal, and the operation input unit 14 to perform manual parking and manual exiting of the vehicle 10. Note that during the automated parking assistance and the automated exiting assistance, the user may be in the vehicle 10, or may be in a state where the user has gotten off the vehicle 10 and is in outside.

For example, the calculation unit 52 performs movement control for executing movement of the vehicle 10 based on the external environment image of the vehicle 10 acquired by the front camera 12Fr, the rear camera 12Rr, the left side camera 12L, and the right side camera 12R, and a parking space designated by the user. The movement control includes parking control for automatically parking the vehicle 10 in a predetermined parking space (target parking position) and exiting control for causing the vehicle 10 to automatically exit a predetermined parking space to a target movement position. The calculation unit 52 can execute the parking control and the exiting control according to an instruction signal input from outside via the input and output unit 50. The input from the outside includes input via wireless communication from an information terminal or the like that is portable by the user of the vehicle 10. The calculation unit 52 can transmit information related to the parking control and the exiting control to the external information terminal via the input and output unit 50.

An EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for an operation from an occupant on the steering 110 and automatic steering during the parking assistance. The resolver 106 detects a rotation angle θm of the EPS motor 104. The EPS ECU 108 controls the entire EPS system 22. The EPS ECU 108 includes an input and output unit (not illustrated), a calculation unit (not illustrated), and a storage unit (not illustrated).

The communication unit 24 may perform wireless communication with another communication device 120. Another communication device 120 includes a base station, a communication device of another vehicle, an information terminal such as a smartphone or a tablet terminal that is portable by the user of the vehicle 10. For example, the communication unit 24 includes an ultra wide band (UWB, registered trademark) interface for performing UWB communication with the information terminal.

The driving force control system 26 includes a driving ECU 130. The driving force control system 26 executes driving force control of the vehicle 10. The driving ECU 130 controls the driving force of the vehicle 10 by controlling an engine or the like (not illustrated) based on an operation performed by the user on the accelerator pedal (not illustrated).

The braking force control system 28 includes a braking ECU 132. The braking force control system 28 executes braking force control of the vehicle 10. The braking ECU 132 controls a braking force of the vehicle 10 by controlling a braking mechanism or the like (not illustrated) based on an operation performed by the user on the brake pedal (not illustrated).

### Display Example of Guide Image

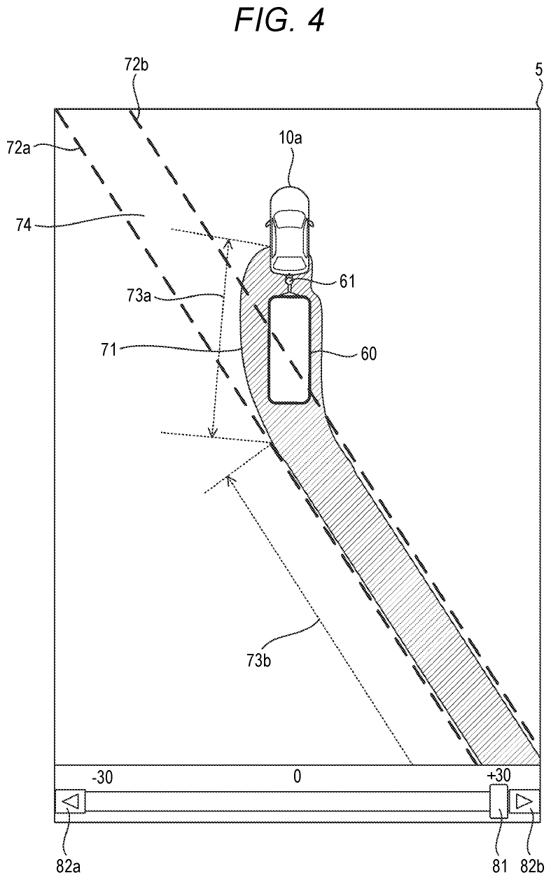

FIG. 4 is a diagram illustrating an example of the first guide image and the second guide image displayed in the peripheral image of the vehicle 10. As illustrated in FIG. 4, the peripheral image 5 in the present example is an image displayed as a top view image. The peripheral image 5 is displayed on the touch panel 42 of the navigation device 18, for example.

The peripheral image 5 in the present example is an image that is displayed when the gear position of the vehicle 10 is in Reverse. In the peripheral image 5, the vehicle 10 towing the trailer is displayed. However, the vehicle displayed in the peripheral image 5 is an “image of the vehicle 10” created by the display control unit 56. In the following description, the “image of the vehicle 10” will simply be referred to as a vehicle 10a. The trailer displayed in the peripheral image 5 is also an “image of the trailer” created by the display control unit 56. In the following description, the “image of the trailer” will simply be referred to as a trailer 60. In the peripheral image 5, a slide bar 81 for instructing a direction of backward traveling of the vehicle 10a towing the trailer 60 is displayed.

By sliding the slide bar 81 in a direction of a left arrow 82a or a direction of a right arrow 82b, the user can instruct the direction of the backward traveling of the vehicle 10a towing the trailer 60 within a range of, for example, −30 degrees to +30 degrees. In the present example, to cause the vehicle 10a towing the trailer 60 to travel backward in a direction of 30 degrees to the right, the slide bar 81 is slid by +30 degrees in the direction of the right arrow 82b. The “right” in the direction of 30 degrees to the right refers to the right direction when, for example, the driver of the vehicle 10a gets on and looks straight ahead. Note that the trailer 60 is connected to the vehicle 10a via a hitch ball 61.

In response to the movement of the slide bar 81, the vehicle 10a calculates a path (first traveling path 73a) for traveling backward while steering so as to turn to the instructed direction (30 degrees to the right). The vehicle 10a further calculates a path (first traveling path 73b) for traveling backward straight while maintaining a relative angle between the vehicle 10a and the trailer 60 towed by the vehicle 10a at 0 degree (hitch angle 0 degree). The first traveling path 73a and the first traveling path 73b are paths through which at least one of the vehicle 10a and the trailer 60 towed by the vehicle 10a passes.

The first traveling path 73a is a traveling path during a period when the steering 110 of the vehicle 10a is being turned, and is therefore calculated as a path of a region with a width larger than that of the first traveling path 73b along which the vehicle 10a travels backward straight. The first traveling path 73b is an extension path continuing from the first traveling path 73a, and is calculated as a path through which the vehicle 10a and the trailer 60 pass in the case of backward traveling with the hitch angle between the vehicle 10a and the trailer 60 remaining at 0 degree. In the present example, the first traveling path 73a is a path of a region calculated when the instructed direction is 30 degrees to the right. The first traveling path 73a is calculated as a path of a region corresponding to the instructed direction (a slide position of the slide bar 81). For example, if the instructed direction is ±0 degree, the first traveling path 73a, together with the first traveling path 73b, is calculated as a traveling path that extends straight to the rear side of the vehicle 10a and the trailer 60.

The vehicle 10a displays a first guide image 71 showing the calculated first traveling path 73a and first traveling path 73b superimposed on the peripheral image 5. The first guide image 71 of the present example is displayed as an image in which the first traveling path 73a and the first traveling path 73b are solid-painted with predetermined colors.

The vehicle 10a calculates a path (second traveling path 74) in a case where the vehicle 10a travels forward (straight ahead) from the position where the hitch angle between the vehicle 10a and the trailer 60 being towed by the vehicle 10a is 0 degree, that is, the position where the vehicle 10a has traveled backward to the first traveling path 73b. The second traveling path 74 is a path through which at least one of the vehicle 10a and the trailer 60 towed by the vehicle 10a passes. The second traveling path 74 is calculated as a straight path extending along the first traveling path 73b.

The vehicle 10a displays second guide images 72a and 72b showing the calculated second traveling path 74 superimposed on the peripheral image 5. In the present example, the second guide images 72a and 72b are displayed as images of two dashed lines along both sides of the second traveling path 74. The second guide images 72a and 72b are displayed along both sides of the second traveling path 74, and are also displayed along both sides of the first traveling path 73b. The second guide images 72a and 72b are images showing the traveling path of the vehicle 10a and the trailer 60 towed by the vehicle 10a when the hitch angle is 0 degree, and are therefore displayed by two dashed lines that are approximately parallel to each other.

After operating the slide bar 81 to instruct the backward traveling direction of the vehicle 10a, when the user steps on the accelerator pedal of the vehicle 10a, the user can cause the vehicle 10a towing the trailer 60 to travel backward along the first guide image 71 by automatic steering while viewing the peripheral image 5 in which the first guide image 71 and the second guide images 72a and 72b are displayed.

The first guide image 71 and the second guide images 72a and 72b are displayed so as not to overlap each other. For example, the first guide image 71 and the second guide images 72a and 72b are displayed such that the second guide images 72a and 72b are displayed on top of the first guide image 71, and the transparency of the second guide images 72a and 72b is set to zero. In the present example, since the vehicle 10a towing the trailer 60 is in the state of backward traveling, in the top view image, the region on the backward traveling direction side as viewed from the vehicle 10a is larger than the region on the forward traveling direction side.

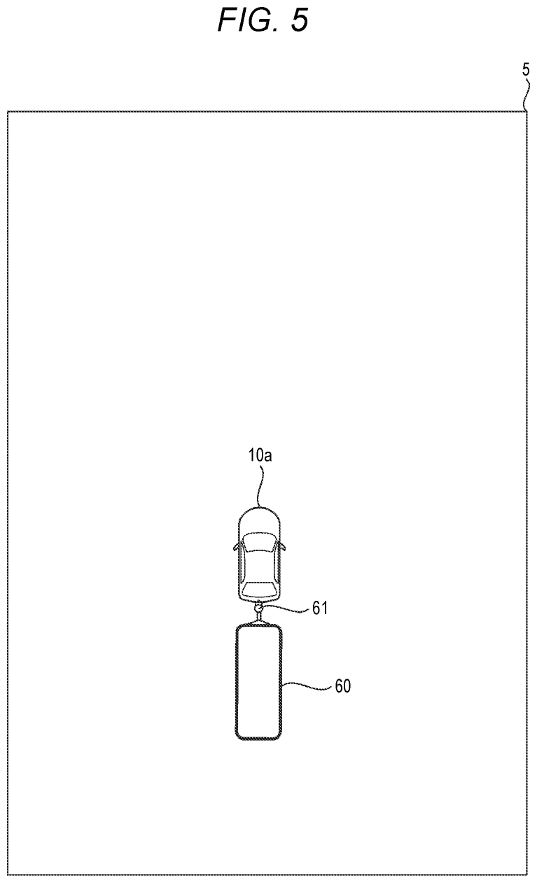

FIG. 5 is a diagram illustrating an example of the peripheral image 5 displayed when the gear position of the vehicle 10 is in Drive. The peripheral image 5 is displayed as, for example, a top view image. The peripheral image 5 displays the vehicle 10a towing the trailer 60 via the hitch ball 61. When the gear position is in Drive, in the peripheral image 5, the guide images showing the traveling paths of the vehicle 10a and the trailer 60 are not displayed. When the gear position is in Drive, in the peripheral image 5, the slide bar 81 for instructing the direction of the backward traveling of the vehicle 10a towing the trailer 60 is also not displayed. In the present example, since the vehicle 10a towing the trailer 60 is in the state of forward traveling, in the top view image, the region on the forward traveling direction side as viewed from the vehicle 10a is larger than the region on the backward traveling direction side.

### Image of Peripheral Region of Vehicle

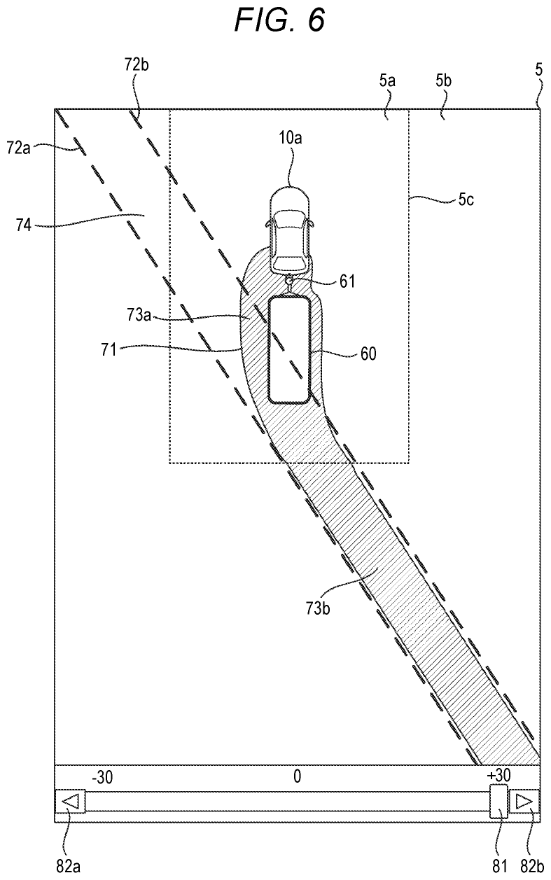

FIG. 6 is a diagram illustrating a first example of an image of a peripheral region of the vehicle 10a displayed in the peripheral image 5. As illustrated in FIG. 6, in the peripheral image 5, the vehicle 10a towing the trailer 60, the first guide image 71 showing the first traveling path 73a and 73b of the vehicle 10a towing the trailer 60, the second guide images 72a and 72b showing the second traveling path 74 of the vehicle 10a towing the trailer 60, the slide bar 81, and the like are displayed. They are the same as the images displayed when the gear position is in Reverse as described with reference to FIG. 4.

A range displayed in the peripheral image 5 includes a first range 5a showing the first peripheral region of the vehicle 10a, and a second range 5b showing the second peripheral region of the vehicle 10a including a region farther from the vehicle 10a than the first peripheral region. For ease of recognition, FIG. 6 illustrates a boundary 5c between the first range 5a and the second range 5b.

The image displayed in the first range 5a is an image generated based on the external environment information of the vehicle 10 acquired by the front camera 12Fr, the rear camera 12Rr, the left side camera 12L, and the right side camera 12R. The image displayed in the second range 5b is an image generated based on the map information (peripheral information) of the vehicle 10a stored in the navigation device 18, for example.

The peripheral image 5 includes, in addition to the image generated based on the external environment information and displayed in the first range 5a, the image generated based on the map information and the like and displayed in the second range 5b outside the first range 5a. Note that the first guide image 71 and the second guide images 72a and 72b are displayed superimposed on the first range 5a and the second range 5b.

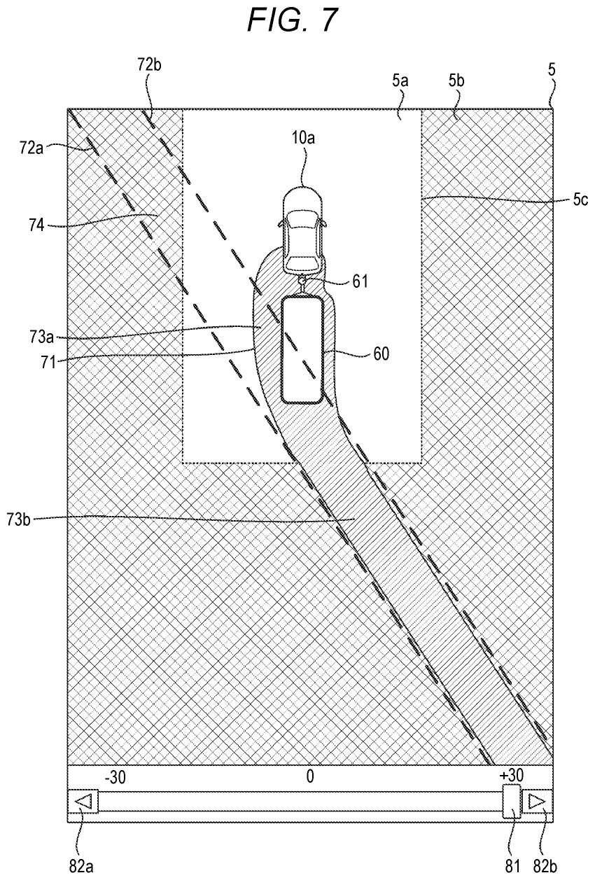

FIG. 7 is a diagram illustrating a second example of the image of the peripheral region of the vehicle 10a displayed in the peripheral image 5. In the first example of FIG. 6 described above, if there is no map information to be displayed in the second range 5b, a predetermined image prepared in advance in the storage unit 54 may be displayed in the second range 5b. For example, as illustrated in FIG. 7, a “mask image” may be displayed in the second range 5b. In this case as well, the first guide image 71 and the second guide images 72a and 72b are displayed superimposed on the first range 5a and the second range 5b.

### Modifications of Guide Image

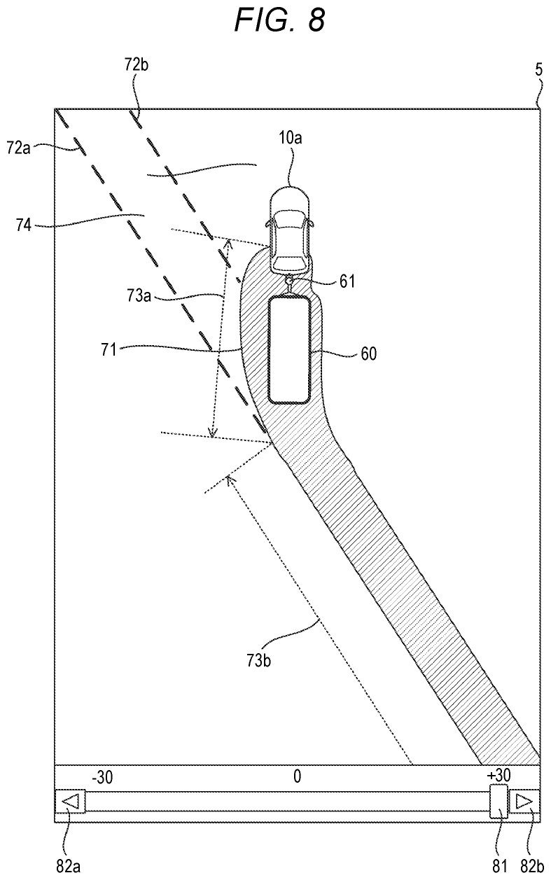

FIG. 8 is a diagram illustrating a first modification of the first guide image and the second guide image displayed in the peripheral image of the vehicle 10.

As illustrated in FIG. 8, the first modification is similar to the display example of the first guide image described with reference to FIG. 4 in that the first guide image 71 showing the first traveling path 73a and the first traveling path 73b is displayed as a solid-painted image superimposed on the peripheral image 5.

On the other hand, with regard to the display of the second guide images 72a and 72b, in the case of the first modification, the second guide images 72a and 72b are displayed only along both sides of the second traveling path 74. It differs from the display example of FIG. 4 in which the second guide images 72a and 72b are displayed along both sides of the second traveling path 74 and also along both sides of the first traveling path 73b.

Note that in the example illustrated in FIG. 8, the first guide image 71 is displayed as a solid-painted image, and the second guide images 72a and 72b are displayed as dashed line images, but is not limited thereto. For example, the first guide image 71 may be displayed as a dashed line image, and the second guide images 72a and 72b may be displayed as solid-painted images.

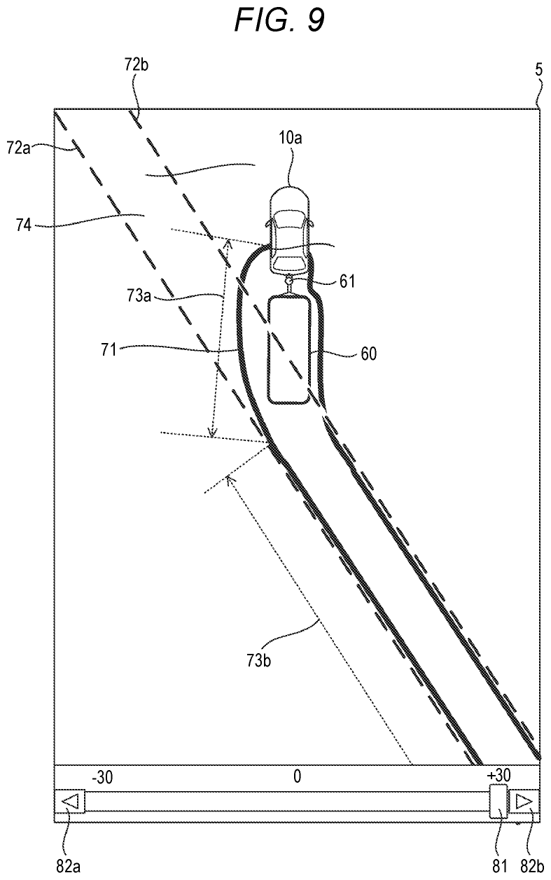

FIG. 9 is a diagram illustrating a second modification of the first guide image and the second guide image displayed in the peripheral image of the vehicle 10.

The second modification is similar to the display example of the second guide image described with reference to FIG. 4 in that the second guide images 72a and 72b showing the second traveling path 74 are displayed superimposed on the peripheral image 5 as images of two dashed lines along both sides of the second traveling path 74.

On the other hand, with regard to the display of the first guide image 71, in the second modification, the first guide image 71 is displayed as an image of two solid lines along both sides of the first traveling path 73a and the first traveling path 73b. It differs from the display example of FIG. 4 in which the first guide image 71 showing the first traveling path 73a and the first traveling path 73b is displayed as a solid-painted image.

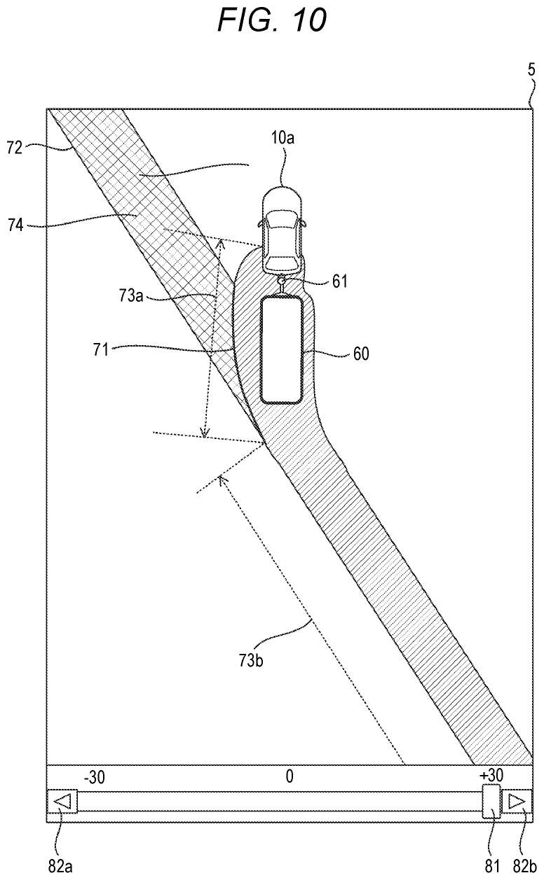

FIG. 10 is a diagram illustrating a third modification of the first guide image and the second guide image displayed in the peripheral image of the vehicle 10.

The third modification is similar to the display example of the first guide image described with reference to FIG. 4 in that the first guide image 71 showing the first traveling path 73a and the first traveling path 73b is displayed as a solid-painted image superimposed on the peripheral image 5.

On the other hand, with regard to the display of the second guide image 72 showing the second traveling path 74, in the case of the third modification, the second guide image 72 showing the second traveling path 74 is displayed only on the second traveling path side in comparison with the first guide image 71, and the second guide image 72 is displayed as a solid-painted image. It differs from the display example of FIG. 4 in which the second guide images 72a and 72b are displayed along both sides of the second traveling path 74 and also along both sides of the first traveling path 73b, and the second guide images 72a and 72b are displayed as images of two dashed lines.

### Guide Image in Rear Image

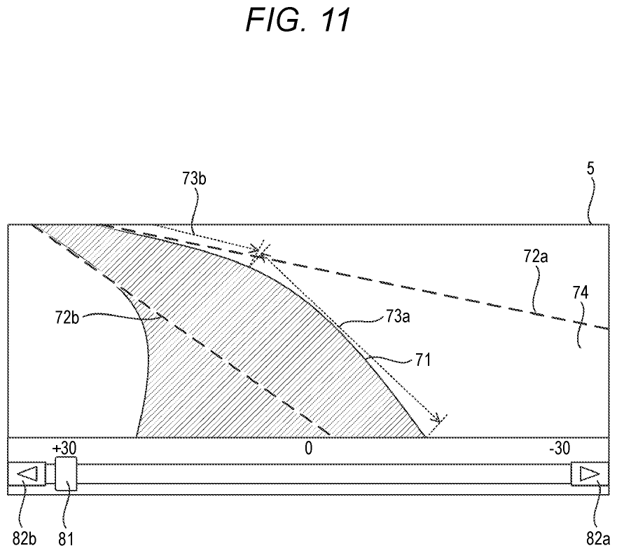

FIG. 11 is a diagram illustrating an example of the guide image displayed in the rear image. The peripheral image 5 in the present example is an image that displays the external environment information of the vehicle 10 as a rear image, and is displayed, for example, when the user selects “display rear image” by a display image switching operation. The gear position of the vehicle 10 is switched to Reverse. The slide bar 81 for instructing the direction of backward traveling of the vehicle 10a towing the trailer 60 is slid by +30 degrees in the direction of the right arrow 82b. That is, the peripheral image 5 in the present example is a rear image that is displayed when “display rear image” is selected by the display image switching operation in the peripheral image 5 (top view image) described with reference to FIG. 4.

As illustrated in FIG. 11, in the peripheral image 5, the first guide image 71 showing the first traveling path 73a and 73b in a solid-painted form is displayed, and the second guide images 72a and 72b are displayed as two dashed lines along both sides of the second traveling path 74. Although not illustrated in the present example for simpleness of viewing, the trailer 60 towed by the vehicle 10a is also illustrated in the peripheral image 5 in reality.

In the above description, the top view image in FIG. 4 and the rear image in FIG. 11 are respectively described as examples of the peripheral image 5 displayed on the touch panel 42 of the navigation device 18, but the peripheral image 5 is not limited thereto. For example, both the top view image and the rear image may be displayed on the touch panel 42. In this case, the top view image and the rear image may be displayed side by side, or may be displayed in a switching mode.

However, when a vehicle (towing vehicle) towing a trailer (towed vehicle) travels backward while turning the steering of the vehicle to change the traveling direction, it is necessary to turn the steering in an opposite direction to the desired traveling direction immediately after the backward traveling, and thus the driving operation becomes difficult. Since the vehicle is towing the trailer, a movement range of the backward traveling while changing the traveling direction is wider (longer). In order to understand the traveling of the vehicle towing the trailer, it is also necessary to understand in advance the traveling paths of the vehicle and the trailer after the backward traveling while changing the traveling direction.

Therefore, in the reverse state where the vehicle 10a towing the trailer 60 is capable of backward traveling, the control device (control ECU 20) in the embodiment of the present disclosure displays, superimposed on the peripheral image 5, the first guide image 71 showing the first traveling paths 73a and 73b of the vehicle 10a and the trailer 60 in the case where the vehicle 10a travels backward from the current position, and the second guide images 72a and 72b showing the second traveling path 74 of the vehicle 10a and the trailer 60 in the case where the vehicle 10a travels forward straight from a position on the first traveling paths 73a and 73b where the relative angle between the vehicle 10a and the trailer 60 is 0 degree. According to this configuration, since it is possible to cause the vehicle 10a towing the trailer 60 to travel backward along the first guide image 71 while viewing the peripheral image 5 in which the first guide image 71 showing the first traveling paths 73a and 73b and the second guide images 72a and 72b showing the second traveling path 74 are displayed, the user can easily understand the traveling path of the vehicle 10a or the trailer 60.

According to the control device, the first guide image 71 and the second guide images 72a and 72b are displayed superimposed on the peripheral image 5 so as not to overlap each other or in different display modes. In this way, it is easier for the user to understand the traveling path of the vehicle 10a or the trailer 60.

According to the control device, in the state where the backward traveling of the vehicle 10a is allowed, the top view image showing the peripheral image 5 is an image in which the region on the backward traveling direction side as viewed from the vehicle 10a is displayed larger. According to this configuration, when the vehicle 10a towing the trailer 60 travels backward, the movement position of the vehicle 10a or the trailer 60 in the first traveling paths 73a and 73b can be easily understood from the larger-displayed first guide image 71.

According to the control device, the top view image showing the peripheral image 5 is generated from the image of the first range 5a showing the first peripheral region of the vehicle 10a generated based on captured images (external environment information), and the image of the second range 5b showing the second peripheral region of the vehicle 10a including a region farther from the vehicle 10a than the first peripheral region generated based on the map information (peripheral information). According to this configuration, the top view image can be displayed in a wide range, and therefore, it is easier for the user to understand the traveling path of the vehicle 10a or the trailer 60.

According to the control device, the first guide image 71 and the second guide images 72a and 72b are displayed superimposed on the first range 5a and the second range 5b. As a result, the first guide image 71 and the second guide images 72a and 72b are displayed over the second range 5b which is wider than the first range 5a, and therefore, it is easier for the user to understand the traveling path of the vehicle 10a or the trailer 60.

### Display of Guide Image in Forward Traveling

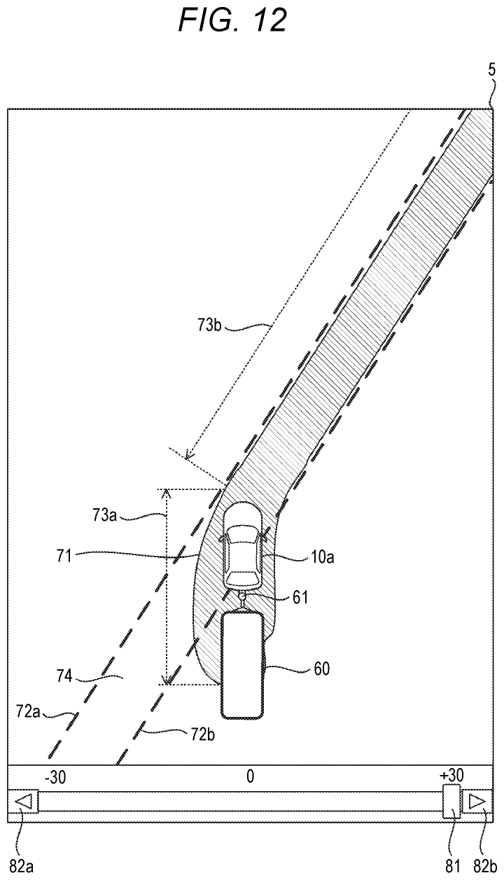

FIG. 12 is a diagram illustrating an example of the first guide image and the second guide image displayed in the peripheral image when the vehicle 10 travels forward. In the above-described embodiment, an embodiment is described in which the guide image showing the traveling path in the case where the vehicle 10a towing the trailer 60 travels backward from the current position, and the guide image showing the traveling path in the case of traveling forward from a position where the vehicle 10a has traveled backward to are displayed, but the present invention is not limited thereto. There may be an embodiment in which the guide image displays, for example, a guide image showing the traveling path in the case where the vehicle 10a towing the trailer 60 travels forward from the current position, and a guide image showing a traveling path in the case of traveling backward from a position where the vehicle 10a has traveled forward to.

The peripheral image 5 (top view image) in the present example is an image that is displayed when the gear position of the vehicle 10 is in Drive. In response to the movement of the slide bar 81, the vehicle 10a calculates a path (first traveling path 73a) for traveling forward while steering so as to turn to the instructed direction (30 degrees to the right). The vehicle 10a further calculates a path (first traveling path 73b) for traveling forward straight while maintaining the relative angle between the vehicle 10a and the trailer 60 towed by the vehicle 10a at 0 degree (hitch angle 0 degree). The first traveling path 73a and the first traveling path 73b are paths through which at least one of the vehicle 10a and the trailer 60 towed by the vehicle 10a passes. The first traveling path 73a is a traveling path during a period when the steering 110 of the vehicle 10a is being turned, and is therefore calculated as a path of a region with a width larger than that of the first traveling path 73b along which the vehicle 10a travels forward straight.

The vehicle 10a displays the first guide image 71 showing the calculated first traveling path 73a and first traveling path 73b superimposed on the peripheral image 5. The first guide image 71 of the present example is displayed as an image in which the first traveling path 73a and the first traveling path 73b are solid-painted with predetermined colors.

The vehicle 10a calculates a path (second traveling path 74) in a case where the vehicle 10a travels backward (straight) from the position where the hitch angle between the vehicle 10a and the trailer 60 being towed by the vehicle 10a is 0 degree, that is, the position where the vehicle 10a has traveled forward to the first traveling path 73b. The second traveling path 74 is a path through which at least one of the vehicle 10a and the trailer 60 towed by the vehicle 10a passes. The second traveling path 74 is calculated as a straight path extending along the first traveling path 73b.

The vehicle 10a displays the second guide images 72a and 72b showing the calculated second traveling path 74 superimposed on the peripheral image 5. In the present example, the second guide images 72a and 72b are displayed as images of two dashed lines along both sides of the second traveling path 74. The second guide images 72a and 72b are displayed along both sides of the second traveling path 74, and are also displayed along both sides of the first traveling path 73b. The second guide images 72a and 72b are images showing the traveling path of the vehicle 10a and the trailer 60 towed by the vehicle 10a when the hitch angle is 0 degree, and are therefore displayed by two dashed lines that are approximately parallel to each other.

After operating the slide bar 81 to instruct the forward traveling direction of the vehicle 10a, when the user steps on the accelerator pedal of the vehicle 10a, the user can cause the vehicle 10a towing the trailer 60 to travel forward along the first guide image 71 by automatic steering while viewing the peripheral image 5 in which the first guide image 71 and the second guide images 72a and 72b are displayed. Note that in the present example, since the vehicle 10a towing the trailer 60 is in the state of forward traveling, in the top view image, the region on the forward traveling direction side as viewed from the vehicle 10a is larger than the region on the backward traveling direction side.

As a result, even when the forward traveling direction of the vehicle 10a towing the trailer 60 is changed, the same effect as the above case of moving while changing the backward traveling direction can be obtained.

Note that the control method described in the above embodiment may be implemented by executing a control program prepared in advance by a computer. The control program is stored in a computer-readable storage medium and executed by being read from the storage medium. The control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

The embodiment of the present disclosure has been described above, but the present invention is not limited to the embodiment described above, and modifications, improvements, and the like may be made as appropriate.

In the present specification, at least the following matters are described. Although corresponding constituent elements or the like in the above-described embodiment are shown in parentheses, the present invention is not limited thereto.
(1) A control device (control ECU 20), including a processor (external environment information acquisition unit 55, display control unit 56) configured to:
acquire external environment information of a moving object (vehicle 10) allowed to perform first traveling and second traveling and towing a trailer (trailer 60); and
control to display a peripheral image (peripheral image 5) of the moving object based on the external environment information, in which
the processor controls to display a guide image superimposed on the peripheral image, in a state where the first traveling of the moving object is allowed, and
the guide image includes:
   a first guide image (first guide image 71) that shows a first traveling path (first traveling path 73a, 73b) of at least one of the moving object and the trailer in a case where the moving object performs the first traveling from a current position; and
   a second guide image (second guide image 72a, 72b) that shows a second traveling path (second traveling path 74) of at least one of the moving object and the trailer in a case where the moving object performs the second traveling from a position on the first traveling path where a relative angle between the moving object and the trailer is a predetermined angle.

According to (1), since the guide image displayed superimposed on the peripheral image of the moving object towing the trailer includes the first guide image and the second guide image, it is possible to display the guide image in a wide range in which the moving object can travel, and it becomes easy for a user to understand a traveling path of the moving object or the trailer.
(2) The control device according to (1), in which
the first guide image and the second guide image are displayed superimposed on the peripheral image, in which the first guide image and the second guide image do not overlap each other.

According to (2), since the first guide image and the second guide image are displayed superimposed on the peripheral image so as not to overlap each other, it becomes easy for the user to understand the traveling path of the moving object or the trailer.
(3) The control device according to (1) or (2), in which
the first guide image and the second guide image are displayed superimposed on the peripheral image in different display modes.

According to (3), since the first guide image and the second guide image are displayed superimposed on the peripheral image in different display modes, it becomes easy for the user to understand the traveling path of the moving object or the trailer.
(4) The control device according to any one of (1) to (3), in which
the peripheral image includes a top view image, and
the top view image in a state where the first traveling of the moving object is allowed is a top view image in which a region on a side of a direction of the first traveling is displayed larger as viewed from the moving object, as compared with the top view image in a state where the second traveling of the moving object is allowed.

According to (4), by making the region on the side of the direction of the first traveling in the state where the first traveling is allowed larger than that in the state where the second traveling is allowed, it becomes easy for the user to understand the traveling path of the moving object or the trailer during the first traveling.
(5) The control device according to any one of (1) to (4), in which
the peripheral image includes a top view image, and
the top view image includes:
   a first range (first range 5a) generated based on the external environment information and showing a first peripheral region of the moving object; and
   a second range (second range 5b) generated based on peripheral information, which is different from the external environment information, of the moving object, and showing a second peripheral region of the moving object including a region farther from the moving object than the first peripheral region.

According to (5), by including in the top view image of the moving object the first range showing the first peripheral region and the second range showing the second peripheral region that includes a region outside the first peripheral region relative to the moving object, it becomes easy for the user to understand the traveling path of the moving object or the trailer.
(6) The control device according to (5), in which
the processor regards an image stored in advance as the second range of the top view image, in a case where the processor does not acquire the peripheral information.

As in (6), when the peripheral information cannot be acquired, it is preferable to use, for example, an image stored in advance as the second range of the top view image.
(7) The control device according to (5) or (6), in which
the guide image is displayed superimposed on the first range and the second range.

According to (7), by displaying the guide image superimposed on the first range and the second range, the guide image can be displayed over a wide region, and it becomes easy for the user to understand the traveling path of the moving object or the trailer.
(8) A control method of a control device that acquires external environment information of a moving object allowed to perform first traveling and second traveling and towing a trailer, and controls to display a peripheral image of the moving object based on the external environment information, in which
a processor of the control device controls to display a guide image superimposed on the peripheral image, in a state where the first traveling of the moving object is allowed, and
the guide image includes:
   a first guide image that shows a first traveling path of at least one of the moving object and the trailer in a case where the moving object performs the first traveling from a current position; and
   a second guide image that shows a second traveling path of at least one of the moving object and the trailer in a case where the moving object performs the second traveling from a position on the first traveling path where a relative angle between the moving object and the trailer is a predetermined angle.

According to (8), since the guide image displayed superimposed on the peripheral image of the moving object towing the trailer includes the first guide image and the second guide image, it is possible to display the guide image in a wide range in which the moving object can travel, and it becomes easy for a user to understand a traveling path of the moving object or the trailer.
(9) A non-transitory computer-readable storage medium storing a control program of a control device that acquires external environment information of a moving object allowed to perform first traveling and second traveling and towing a trailer, and controls to display a peripheral image of the moving object based on the external environment information, in which
the control program causes a processor of the control device to control to display a guide image superimposed on the peripheral image, in a state where the first traveling of the moving object is allowed, and
the guide image includes:
   a first guide image that shows a first traveling path of at least one of the moving object and the trailer in a case where the moving object performs the first traveling from a current position; and
   a second guide image that shows a second traveling path of at least one of the moving object and the trailer in a case where the moving object performs the second traveling from a position on the first traveling path where a relative angle between the moving object and the trailer is a predetermined angle.

According to (9), since the guide image displayed superimposed on the peripheral image of the moving object towing the trailer includes the first guide image and the second guide image, it is possible to display the guide image in a wide range in which the moving object can travel, and it becomes easy for a user to understand a traveling path of the moving object or the trailer.

What is claimed is:

1. A control device, comprising a processor configured to:
acquire external environment information of a moving object allowed to perform first traveling and second traveling and towing a trailer; and
control to display a peripheral image of the moving object based on the external environment information, wherein the processor controls to display a guide image superimposed on the peripheral image, in a state where the first traveling of the moving object is allowed, and
the guide image includes:
a first guide image that shows a first traveling path of at least one of the moving object and the trailer in a case where the moving object performs the first traveling from a current position; and
a second guide image that shows a second traveling path of at least one of the moving object and the trailer in a case where the moving object performs the second traveling from a position on the first traveling path where a relative angle between the moving object and the trailer is a predetermined angle.

2. The control device according to claim 1, wherein
the first guide image and the second guide image are displayed superimposed on the peripheral image, in which the first guide image and the second guide image do not overlap each other.

3. The control device according to claim 1, wherein
the first guide image and the second guide image are displayed superimposed on the peripheral image in different display modes.

4. The control device according to claim 1, wherein
the peripheral image includes a top view image, and
the top view image in a state where the first traveling of the moving object is allowed is a top view image in which a region on a side of a direction of the first traveling is displayed larger as viewed from the moving object, as compared with the top view image in a state where the second traveling of the moving object is allowed.

5. The control device according to claim 1, wherein
the peripheral image includes a top view image, and
the top view image includes:
a first range generated based on the external environment information and showing a first peripheral region of the moving object; and
a second range generated based on peripheral information, which is different from the external environment information, of the moving object, and showing a second peripheral region of the moving object including a region farther from the moving object than the first peripheral region.

6. The control device according to claim 5, wherein
the processor regards an image stored in advance as the second range of the top view image, in a case where the processor does not acquire the peripheral information.

7. The control device according to claim 5, wherein
the guide image is displayed superimposed on the first range and the second range.

8. A control method of a control device that acquires external environment information of a moving object allowed to perform first traveling and second traveling and towing a trailer, and controls to display a peripheral image of the moving object based on the external environment information, wherein
a processor of the control device controls to display a guide image superimposed on the peripheral image, in a state where the first traveling of the moving object is allowed, and
the guide image includes:
a first guide image that shows a first traveling path of at least one of the moving object and the trailer in a case where the moving object performs the first traveling from a current position; and
a second guide image that shows a second traveling path of at least one of the moving object and the trailer in a case where the moving object performs the second traveling from a position on the first traveling path where a relative angle between the moving object and the trailer is a predetermined angle.

9. A non-transitory computer-readable storage medium storing a control program of a control device that acquires external environment information of a moving object allowed to perform first traveling and second traveling and towing a trailer, and controls to display a peripheral image of the moving object based on the external environment information, wherein
the control program causes a processor of the control device to control to display a guide image superimposed on the peripheral image, in a state where the first traveling of the moving object is allowed, and
the guide image includes:
a first guide image that shows a first traveling path of at least one of the moving object and the trailer in a case where the moving object performs the first traveling from a current position; and
a second guide image that shows a second traveling path of at least one of the moving object and the trailer in a case where the moving object performs the second traveling from a position on the first traveling path where a relative angle between the moving object and the trailer is a predetermined angle.
